(19) United States
(12) Patent Application Publication
(10) Pub. No.: US 2021/0354784 A1
(43) Pub. Date: Nov. 18, 2021

(54) FOLDABLE BOAT

(71) Applicant: Jason Ward, Champaign, IL (US)

(72) Inventor: Jason Ward, Champaign, IL (US)

(21) Appl. No.: 17/317,107

(22) Filed: May 11, 2021

Related U.S. Application Data
(60) Provisional application No. 63/024,523, filed on May 14, 2020.

(51) Int. Cl. B63B 7/02; B60F 3/00; B63H 21/17

(52) U.S. Cl. CPC B63B 7/02; B63H 21/17; B60F 3/0007; B60F 3/003

(57) ABSTRACT

Embodiments of the present invention provide foldable boat with at least two shell members, capable of being transformed between a storage configuration and a deployment configuration. The boat comprises an aft shell and a forward shell, coupled together by respective pluralities of interlocking pleats. The storage configuration comprises the two shell members folded together to form an interior storage space for carrying supplies and gear and allows the boat to be transported via a plurality of wheels and an extendable handle. A plurality of handles enables a user to unfold the boat into the deployment configuration, and a locking rod enables the boat to be retained in said configuration while in use on water as a boat or on snow as a sled.

### CROSS-REFERENCE TO RELATED APPLICATIONS

This application claims the benefit of U.S. Provisional Patent App. No. 63/024,523, filed May 14, 2020.

### BACKGROUND OF THE INVENTION

The present invention relates to boating. Particularly, a folding boat having two shell members that form an interior cargo space, allowing for easy transportation of both supplies within and the boat itself.

Modern boats and similar sporting vessels, when not moored at a port or dock, require transportation to and from a body of water. The owner generally does this through use of a trailer towed behind a vehicle. Not only does this present an additional subset of maintenance, care, and equipment, the process of loading it up and unloading it into the water can be cumbersome to the point that it greatly limits the owner's time and enjoyment of the vessel. Depending on the size of the vessel, additional licensing or training to transport the vessel as well. These impositions can be severely limiting for anyone wanting to get involved or begin participating in boating.

Further, in emergency or survival situations, such as flooding, boats are a boon for both survival and rescue efforts. First responders and victims alike rely on waterborne vessels for escape and refuge from disaster. However, not every person affected by natural disaster owns a boat or similar vessel. In some instances, rescuers may attempt to airdrop some form of flotation device or inflatable boat to those in peril or need of rescue, but the results are imperfect and dangerous. Dropping solid hulled vessels to victims carries a risk of bodily harm, injury, or even death, since the boat may rotate and falter during the fall by catching wind and air turbulence in the interior of the boat; and may strike a person or property, causing potentially irreparable damages. Likewise, inflatable boats may be carried away by wind if inflated prior to or during a drop and the boat may prove cumbersome to the victim either in inflating it, or in navigating the boat in rough weather or waters.

Folding boats known in the art typically include a flexible material that may be folded up for storage or transportation, accompanied by a number or removeable supports that must be inserted as the boat is assembled for use on the water. Other vessels known in the art include a boat that has multiple folding portions, with multiple hinges, that result in a compact shape unfolded to form a boat. These boats, however, present their own set of challenges. Namely, overall stability is compromised in the name of portability. Removeable supports carry a risk of loosening and collapsing or may be lost by the owner between uses. Systems with multiple hinges are also subject to failure, imbuing the vessel with a noticeable ‘wobble’ as the hinges introduce structural play once the vessel is deployed.

There is a need in the art for a foldable boat that has structural stability during use, while maintaining the advantages of portability and ease-of-use that comes with a folding vessel. There is also a pressing need in the art for a foldable boat that can be safely utilized in emergency and survival situations without presenting increased harm or difficulty of operation to both rescuer and victim users.

The present invention attempts to remedy the shortcomings of prior art vessels by providing a foldable boat having a solid body comprised of two shell members, each having a plurality of interlocking pleats capable of coupling the shell members together to form a boat. The present invention also attempts to remedy shortcomings of prior art vessels by further providing a foldable boat having two shell members that form an interior cargo space, as well as the foldable boat being capable of adequate flotation in both the folded and unfolded configurations.

### BRIEF DESCRIPTION OF THE INVENTION

The present invention provides a boat capable of being folded, stored, transported, and deployed without additional equipment or requirements. In one embodiment of the invention, the foldable boat is configured with a storage configuration and a deployment configuration. The foldable boat comprises at least two shell members, each having a bottom and a plurality of sidewalls, wherein each shell member is configured to engage and couple the other both in the storage configuration and in the deployment configuration.

Each shell member comprises a plurality of interlocking pleats configured with to couple another plurality of interlocking pleats of another shell member, thereby forming a waterborne vessel while in the deployment configuration. The bottom of each shell member further comprises tracking ribs spanning a length of the shell member and configured to aid in water displacement and stability while the boat is in use. The invention further has at least one locking rod spanning a width of the boat and configured to couple and retain two pluralities of interlocking pleats, thereby securing the two pluralities of interlocking pleats together and locking the boat in the deployment configuration. In some embodiments of the invention, the plurality of interlocking pleats may further comprise a hinge disposed at a top of the sidewall of the shell member, the hinge configured to assist in transformation of the boat between the storage and deployment configurations.

In some embodiments, the foldable boat comprises a plurality of handles disposed along at least one outer surface of the boat and configured to allow a user to secure the boat while in either the storage or deployment configuration. The plurality of handles is also configured to allow a user to secure the boat in the storage configuration by connecting two handles together through external securing means, such as ropes or straps.

In some embodiments of the invention, the shell members may be locked together in the storage configuration such that the shell members form an interior cargo space capable of watertight storage.

In another embodiment of the invention, an extendable handle is nested within a shell member and configured to allow a user to extend and retract the handle for further ease of transportation or as an additional means of securing the boat. In other embodiments of the invention, the extendable handle may be configured serve as a bumper member capable of absorbing impact forces. A plurality of tie downs and netting may also be disposed throughout an interior of each shell member, both facilitating storage of supplies or gear within the boat and also offering further means of securing the boat itself.

In other embodiments, the boat may be configured for use on both water and snow, such that the bottom of each shell member comprises a coating capable of withstanding typical frictional and abrasive forces from contact with snow and snowy surfaces. The extendable handle may also be configured as an additional tow point, allowing the foldable boat to be pulled behind both watercraft and snowcraft, in either the storage configuration or the deployment configuration. In some embodiments, the extendable handle may also comprise attachment points for a sled pulling harness.

In some embodiments, the at least two shell members may comprise an aft shell and a forward shell. The aft shell comprises at least one integrated seat spanning a width of the shell. In some embodiments, a rear sidewall of the aft shell may further comprise a cutout configured to accept a motor. The forward shell comprises at least one integrated seat spanning a width of the shell. In some embodiments, a front sidewall of the forward shell may be configured to form an obtuse angle with a bottom plane of the forward shell.

In another embodiment of the invention, a plurality of recessed wheels are coupled to at least one shell member and configured to allow reduced friction and difficulty for a user in transporting the boat.

The methods, systems, and apparatuses are set forth in part in the description which follows, and in part will be obvious from the description, or can be learned by practice of the methods, apparatuses, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

FIG. 1 illustrates a perspective view of the foldable boat of the invention in the deployment configuration.

FIG. 2 illustrates a perspective view of the foldable boat of the invention in the storage configuration.

FIG. 3 illustrates a perspective view of a shell member of the invention.

FIG. 4 illustrates an additional perspective view of the foldable boat of the invention in the deployment configuration.

FIG. 5 illustrates a perspective view of a larger embodiment of the foldable boat of the invention while in the deployment configuration.

### DETAILED DESCRIPTION OF THE INVENTION

The present invention is described in reference to the accompanying drawings and following embodiments that are presented for the purpose of illustration and should not be construed to limit the scope of the invention thereto.

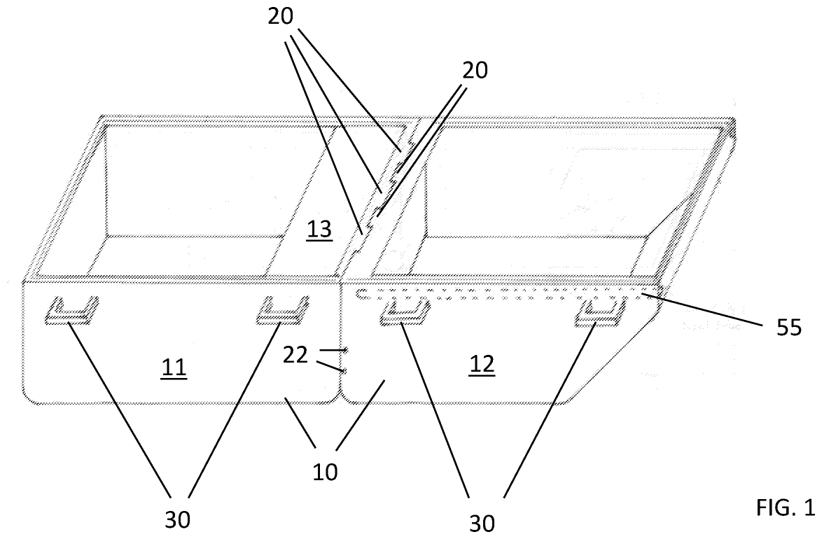

On embodiment of the present invention, as shown in FIG. 1, provides a foldable boat having a storage configuration and a deployment configuration. The foldable boat comprises at least two shell members 10 configured to couple together at an end, forming a hinged attachment point to allow transformation of the boat between the storage configuration and the deployment configuration.

The at least two shell members 10 comprise an aft shell 11 and a forward shell 12. While in the deployment configuration, the aft shell 11 forms the stern, or rear, of the boat and the forward shell 12 forms the bow, or front, of the boat. Each shell member comprises an enclosure formed by bottom and a plurality of sidewalls. Further, each shell member comprises at least one seat 13 disposed within the enclosure and spanning an entire width thereof, the at least one seat configured to accommodate a user.

A plurality of interlocking pleats 20 comprises one of the plurality of sidewalls of each shell member. The plurality of interlocking pleats 20 is further configured to couple and retain a plurality of interlocking pleats of another shell member, thereby coupling the respective shell members to one another. A hinge mechanism may further be disposed along a top end of the plurality of interlocking pleats and spanning a width of the foldable boat; the hinge mechanism configured to allow stable transformation of the boat. The hinge mechanism may also comprise a hinge rod 21 disposed through a top end of corresponding pluralities of interlocking pleats.

The foldable boat further comprises at least one locking rod 22 disposed through a lower end of corresponding pluralities of interlocking pleats 20 and spanning the width of the boat. The at least one locking rod 22 is configured to retain together two pluralities of interlocking pleats 20, thereby locking the boat in the deployment configuration. The at least one locking rod is further configured to be removeable. In some embodiments, a plurality of locking clamps may be disposed upon the sidewalls of each shell member and configured to work in tandem with the at least one locking rod to retain the boat in the deployment configuration.

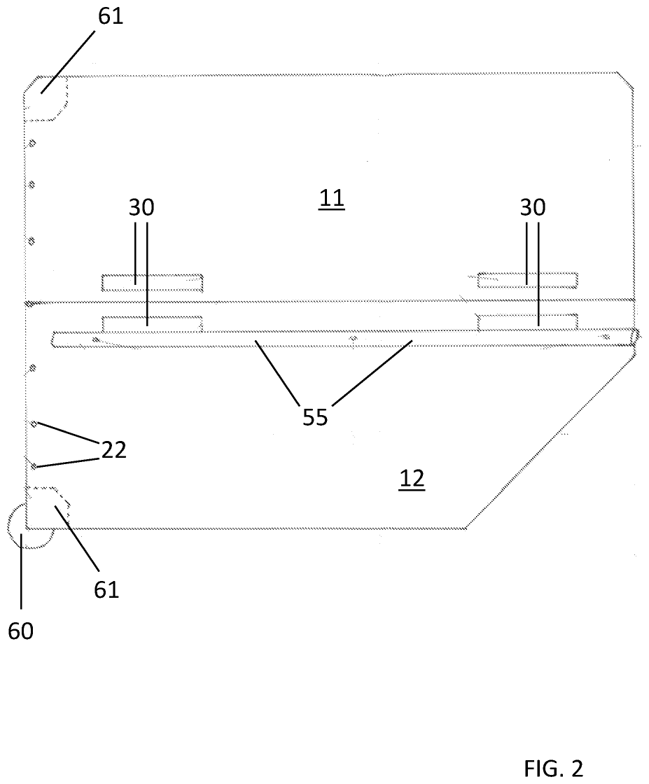

While in the storage configuration, as shown in FIG. 2, the at least two shell members are configured such that the bottoms of each member form parallel planes with one another while facing in opposite directions. The at least two shell members thereby form an enclosure having an interior that may be configured as cargo space for supplies. In some embodiments, each shell member 10 further comprises a gasket disposed along a top of the plurality of sidewalls, the gasket configured to create a watertight seal while the boat is in the storage configuration.

A plurality of handles 30 is further disposed along an exterior of the sidewalls of each shell member 10, such that the handles 30 form complimentary pairs with other handles of other shell members. The plurality of handles 30 is further configured to allow a user to grab the boat in either the storage or deployment configurations and transport or secure the boat as needed. The plurality of handles 30 is also configured to accept various means of mooring or anchoring, such as ropes or straps, and two handles may be coupled together to secure the boat in a storage configuration. In some embodiments, the foldable boat may further comprise a plurality of clasps configured to further couple and retain two shell members together while the boat is in the storage configuration.

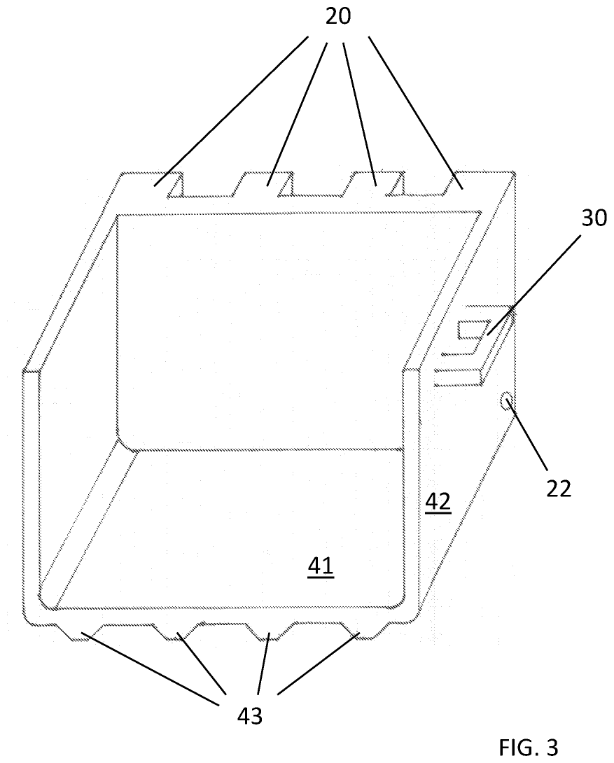

Each shell member, as shown in FIG. 3, comprises an inner layer 41 and an outer layer 42 to form the main body of the shell member 10. The inner layer 41 and the outer layer 42 may comprise a durable and rigid, yet light, material, such as a hard plastic or polymer. The bottom of each shell member further comprises tracking ribs 43 spanning a length of the shell member 20 and configured to increase stability and displacement while the foldable boat is in the deployment configuration and in use. Between the outer layer and the inner layer of the main body, each shell member further comprises a system of structural connectors and solid fill supports, both configured to increase stability while reducing overall weight of the foldable boat.

A plurality of retention mechanisms, such as tie downs or netting, are disposed along at least one interior surface of each shell member and configured for supply and gear storage, as well as being configured for additional securing points while the foldable boat is in either the storage or deployment configurations.

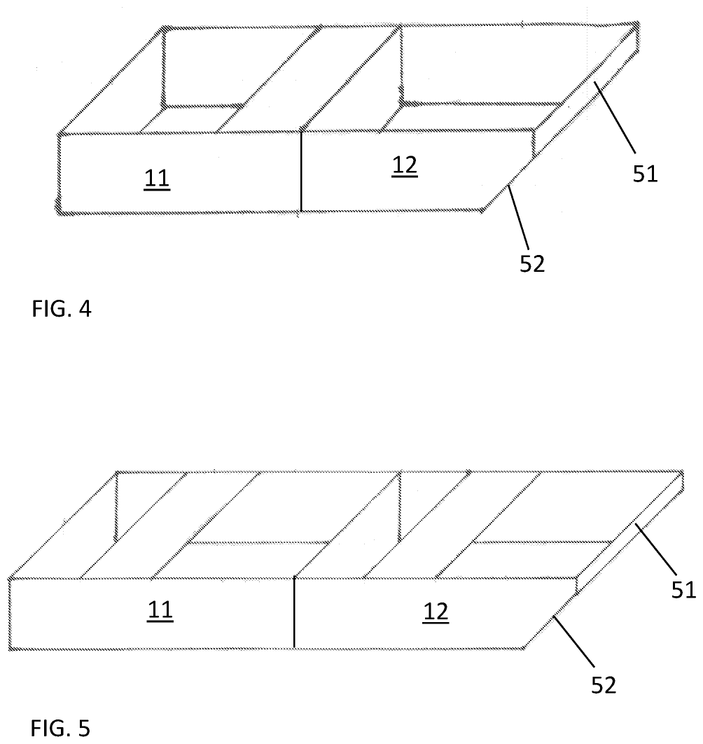

The forward shell 12, as shown in FIGS. 4-5, comprises a front sidewall having a planar section 51 along with a curved section 52, the curved section configured to form an obtuse angle with a plane of the bottom of the shell member, forming a sloped bottom surface of the shell member. The sloped bottom surface of the forward shell 12 further comprises tracking ribs 43 and is configured to further increase stability and smooth movement of the foldable boat while in use. In some embodiments of the invention, the planar section of the forward shell further comprises an attachment point 50 capable of accommodating a small motor, such as a trolling motor. The aft shell 11 also comprises a cutout disposed through a rear sidewall thereof, the cutout comprising an attachment point able to accommodate an appropriately sized boating motor.

The forward shell 12 further comprises at least one extendable handle disposed along a top edge of a sidewall of the shell member, the extendable handle configured to allow additional points for a user to handle the foldable boat, as well as additional mooring and anchoring points. The extendable handle 55 may also comprise an impact-resistant material, allowing the handle to function as a bumper structure. The extendable handle 55 may further comprise a cylindrical member disposed within the main body of the forward shell and configured to extend from an opening disposed through a front sidewall of the forward shell.

The foldable boat is also capable of use in snow, whereby the deployment configuration functions similar to a sled. In such situations, the extendable handle further comprises at least one attachment point to accommodate a sled pulling harness. Further, the extendable handle, as well as the plurality of handles of the shell members, may be utilized to couple multiple boats to one another while they are in the storage state, allowing for mass transportation of multiple foldable boats, either by a user dragging them or by hauling the foldable boats behind a watercraft or snowcraft. Further, the extendable handle and the plurality of handles are configured to function as towing points, allowing the foldable boat to be towed behind a watercraft or snowcraft while the boat is in the deployment configuration.

A plurality of wheels 60 is also coupled to at least one axle disposed through the main body of the forward shell such that the axle is parallel to the bottom surface of the forward shell, and spanning the width of the main body at a lower-rear corner. The forward shell further comprises a number of recesses 61 cut out of the main body through the bottom and rear sidewall, configured to accept and rotationally retain each wheel of the plurality of wheels 60. The aft shell 11 also comprises a corresponding number of recesses 61 cut out of the main body through the bottom and front sidewall of the aft shell 11, configured to accept each wheel of the plurality of wheels while the boat is in the deployment configuration. The recesses 61 of the aft shell 11 and the recesses of the forward shell 12, when the foldable boat is in the deployment configuration, align to form wheel recesses. Each wheel of the plurality of wheels 60 is configured to partially jut downward from the wheel recesses. When the foldable boat is in the storage configuration, the plurality of wheels 60 is configured to facilitate reduced friction and ease of movement for the user while transporting the foldable boat. The plurality of wheels 60, along with the internal cargo space, allows the foldable boat to be used as moveable storage for boating supplies and gear while in the storage configuration.

The foldable boat may further comprise various sizes of boats, in both dimension and capacity. Larger boat sizes further comprise additional and removeable seats, handles, and retention mechanisms that are capable of being stored within the foldable boat while it is in the storage configuration. Larger boat sizes may also comprise an additional plurality of wheels disposed within the recesses of the aft shell, and rotationally retained by an axle disposed therethrough, similar to that of the forward shell.

Those of ordinary skill in the art will understand and appreciate that the foregoing description of the invention has been made with reference to certain exemplary embodiments of the invention, which describe a foldable boat. Those of skill in the art will understand that obvious variations in system configuration, protocols, parameters or properties may be made without departing from the scope of the invention which is intended to be limited only by the claims appended hereto.

What is claimed is:

1. A foldable boat, comprising:
a. a storage configuration and a deployment configuration
b. at least two shell members, comprising an aft shell and a forward shell;
c. a locking rod
d. a plurality of handles
e. an extendable handle
f. a plurality of wheels;
g. wherein the aft shell and the forward shell comprise an enclosure having a bottom and a plurality of sidewalls;
h. wherein a sidewall of the aft shell comprises a plurality of interlocking pleats
i. wherein a sidewall of the forward shell comprises a plurality of interlocking pleats;
j. wherein the plurality of interlocking pleats of the forward shell couples and retains the plurality of interlocking pleats of the aft shell; and
k. wherein the locking rod is disposed through the coupled pluralities of interlocking pleats of the aft shell and the forward shell to retain the coupled pluralities of interlocking pleats together.

2. The foldable boat of claim 1, further comprising tracking ribs disposed along the bottom of the forward shell and the aft shell.

3. The foldable boat of claim 2, wherein the aft shell comprises an attachment point configured to accommodate a motor.

4. The foldable boat of claim 3, further comprising at least one seat member disposed within an interior of the at least two shell members.

5. The foldable boat of claim 4, further comprising a plurality of retention mechanisms disposed within the interior of the at least two shell members.

6. The foldable boat of claim 5, wherein the boat is capable of being locked in the storage configuration.

7. The foldable boat of claim 6, wherein the boat is capable of being locked in the deployment configuration.

8. The foldable boat of claim 7, wherein the extendable handle comprises an attachment for a sled pulling harness.

9. The foldable boat of claim 1, wherein the at least two shell members comprise a main body having an inner layer and an outer layer.

10. The shell members of claim 9, further comprising a plurality of support members and solid fill supports disposed between the inner layer and the outer layer.
